(19) United States
(12) Patent Application Publication
(10) Pub. No.: US 2019/0028894 A1
(43) Pub. Date: Jan. 24, 2019

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: Hidehiko Yokoyama, Kashiwa-shi (JP)

(21) Appl. No.: 16/141,826

(22) Filed: Sep. 25, 2018

Related U.S. Application Data
(63) Continuation of application No. 15/150,188, filed on May 9, 2016.

(30) Foreign Application Priority Data
May 14, 2015 (JP) 2015-099117

(51) Int. Cl. H04W 12/06; G06F 21/32; G06F 3/12

(52) U.S. Cl. CPC H04W 12/06; G06F 21/32; G06F 3/1292; G06F 3/1239; H04M 1/673; G06F 3/1222; G06F 3/1238

(57) ABSTRACT

In an information processing apparatus that wirelessly communicates with a terminal apparatus, lock information is acquired from the terminal apparatus when the terminal apparatus and the information processing apparatus are in close proximity to each other and shift into a communicable state. Based on the acquired lock information, execution of predetermined functional processing to be executed by the information processing apparatus is restricted.

### CROSS-REFERENCE TO RELATED APPLICATION

This application is a Continuation of U.S. application Ser. No. 15/150,188, filed May 9, 2016, which claims the benefit of Japanese Patent Application No. 2015-099117, filed May 14, 2015. These documents are hereby incorporated by reference herein in their entirety.

### BACKGROUND

### Field

Aspects of the present invention generally relate to an information processing apparatus, a control method for the information processing apparatus, and a storage medium.

### Description of the Related Art

In recent years, there has been an increasing number of terminal apparatuses, such as smartphones and tablets, equipped with proximity wireless communication technologies. As a result, various information processing apparatuses, including image forming apparatuses having multiple functions, are also equipped with proximity wireless communication technologies. Therefore, various kinds of cooperative operations have been performed between the terminal apparatuses and the information processing apparatuses.

For example, a system has been developed for determining whether to allow a user of a terminal apparatus to use a function or service provided by an information processing apparatus. In this system, when the terminal apparatus is brought into contact with the information processing apparatus, the information processing apparatus acquires identification information of the terminal apparatus using proximity wireless communication. Whether the user can use the function or service is determined based on the acquired identification information.

In an information processing apparatus installed in a place such as an office where communication using a portable telephone network is impossible, entering a user identification (ID) and a password is always requested. Meanwhile, in an information processing apparatus installed in a place where communication using a portable telephone network is possible, spoofing of a portable terminal's identification may occur.

### SUMMARY OF THE INVENTION

Aspects of the present invention are directed to a technique in which, when a terminal apparatus is brought near an information processing apparatus, even if identification information of the terminal apparatus is registered, functional processing is restricted with a process for determining whether the terminal apparatus is used in a locked state or an unauthorized person is using the terminal apparatus.

Aspects of the present invention are generally directed to an image forming apparatus configured as follows.

According to an aspect of the present invention, an information processing apparatus that wirelessly communicates with a terminal apparatus includes an acquisition unit configured to acquire lock information from the terminal apparatus when the terminal apparatus and the information processing apparatus are in close proximity to each other and shift into a communicable state and a restriction unit configured to restrict execution of predetermined functional processing to be executed by the information processing apparatus based on the lock information acquired by the acquisition unit.

Further features of aspects of the present invention will become apparent from the following description of exemplary embodiments with reference to the attached drawings.

### BRIEF DESCRIPTION OF THE DRAWINGS

FIG. 1 is a block diagram illustrating an example of an inner configuration of a terminal apparatus.

FIG. 2 is a diagram illustrating a user interface (UI) screen displayed on a liquid crystal display (LCD) panel.

FIG. 3 is a block diagram illustrating an example of an information processing apparatus.

FIG. 4 is a sequence diagram illustrating a communication sequence between the terminal apparatus and an image forming apparatus.

FIG. 5 is a flowchart illustrating a control method for the terminal apparatus.

FIG. 6 is a flowchart illustrating the control method for the terminal apparatus.

FIG. 7 is a flowchart illustrating a control method for the information processing apparatus.

FIG. 8 is a flowchart illustrating the control method for the information processing apparatus.

FIG. 9 is a flowchart illustrating a control method for the information processing apparatus.

FIG. 10 is a diagram illustrating a data structure of a registered identification (ID) list and user entries.

### DESCRIPTION OF THE EMBODIMENTS

Exemplary embodiments of the present invention will be described below with reference to the drawings.

### Description of System Configuration

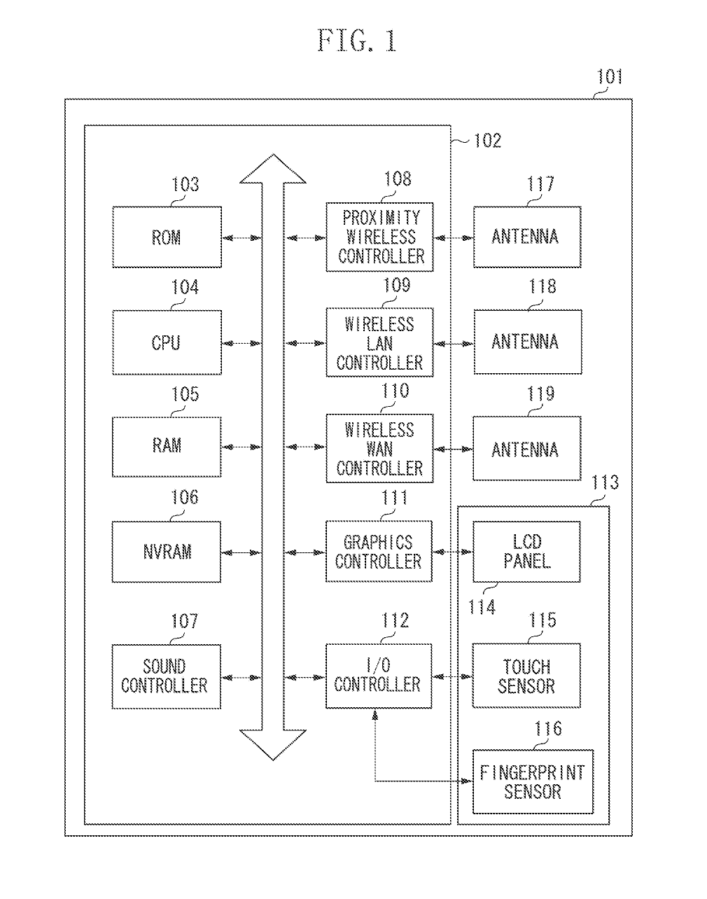

A first exemplary embodiment of the present invention will be described below. FIG. 1 is a block diagram illustrating an example of an inner configuration of a terminal apparatus 101, such as a portable terminal provided with a proximity wireless communication function, for implementing the present exemplary embodiment. In the present exemplary embodiment, a terminal apparatus and an information processing apparatus are controlled so as to shift into a communicable state when the terminal apparatus and the information processing apparatus are in close proximity to each other.

In FIG. 1, the terminal apparatus 101 includes a main substrate 102, a front panel 113, and antennas 117 to 119, which are housed in an enclosure. The main base 102 includes a nonvolatile read only memory (ROM) 103 for storing a system boot program and an operating system. The main base 102 further includes a volatile random access memory (RAM) 105 for temporarily storing a program and data, and a nonvolatile RAM (NVRAM) 106 for storing an application program and data relating to the application program. A central processing unit (CPU) 104 sequentially executes the program stored in each of the ROM 103, the RAM 105, and the NVRAM 106. The main base 102 further includes a sound controller 107 connected to a speaker (not illustrated) and a microphone (not illustrated), for audio input and output.

A proximity wireless controller 108 controls proximity wireless communication, such as near field communication (NFC), FeliCa®, and MIFARE®, with another apparatus via the antenna 117.

A wireless local area network (LAN) controller 109 controls wireless LAN communication, based on, for example, the Institute of Electrical and Electronics Engineers (IEEE) 802.11n, with another apparatus or an access point via the antenna 118.

A wireless wide area network (WAN) controller 110 controls wireless WAN communication, based on, for example, Long Term Evolution (LTE), with a base station via the antenna 119. The main base 102 further includes a graphics controller 111 for performing display on a display apparatus, and an input/output (I/O) controller 112 for inputting and outputting data from and to a device connected thereto.

The front panel 113 includes a liquid crystal display (LCD) panel 114 connected to the graphics controller 111 to display image information. The front panel 113 further includes a touch sensor 115 for detecting the position of a touch of a finger or touch pen on the LCD panel 114, and a fingerprint sensor 116. The touch sensor 115 and the fingerprint sensor 116 are connected to the I/O controller 112.

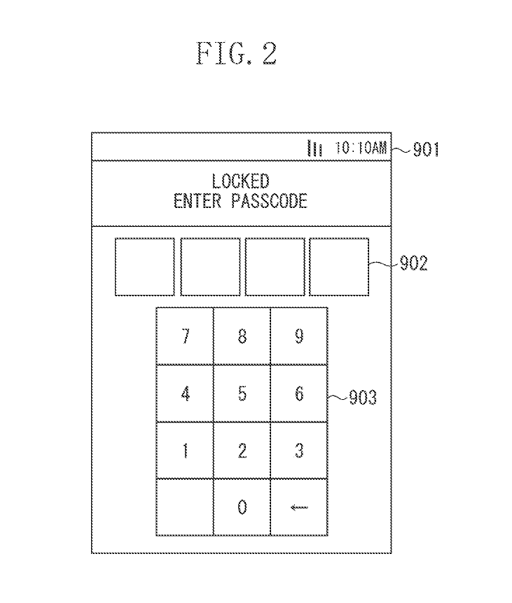

FIG. 2 is a diagram illustrating a user interface (UI) screen displayed on the LCD panel 114 illustrated in FIG. 1. This is an example of a lock screen layout to be displayed on the LCD panel 114 either when the terminal apparatus 101 is activated or when no operation is performed for a predetermined time.

In FIG. 2, a status display field 901 displays information such as signal strength and the clock time. When a number in a soft keyboard portion 903 is touched, the touched number is set in a passcode entry field 902.

In this example, a lock screen is provided to perform locking release with passcode authentication. In this lock screen, a shift to an operation screen is allowed only when a four-digit number registered beforehand and a four digit number having been input match with each other. As such a locking release method, other than the passcode authentication, there is a face recognition method for determining whether a face image captured by a camera matches with a face image registered beforehand. There is also a fingerprint authentication method for determining whether fingerprint information read by the fingerprint sensor 116 matches with fingerprint information registered beforehand.

In the present exemplary embodiment, “lock information” refers to information indicating whether the current state is a state where no request is accepted from a user in a case where a request to the terminal apparatus 101 continues for a predetermined time (a locked state). An example of the lock information will be described below.

In the present exemplary embodiment, information indicating a screen locked state is used as an example of the lock information. Here, the proximity wireless communication is disabled when transition of the lock information from an unlocked state (a normal state) to the locked state is performed. Further, the terminal apparatus 101 is configured to enable the proximity wireless communication when transition from the locked state to the unlocked state is performed.

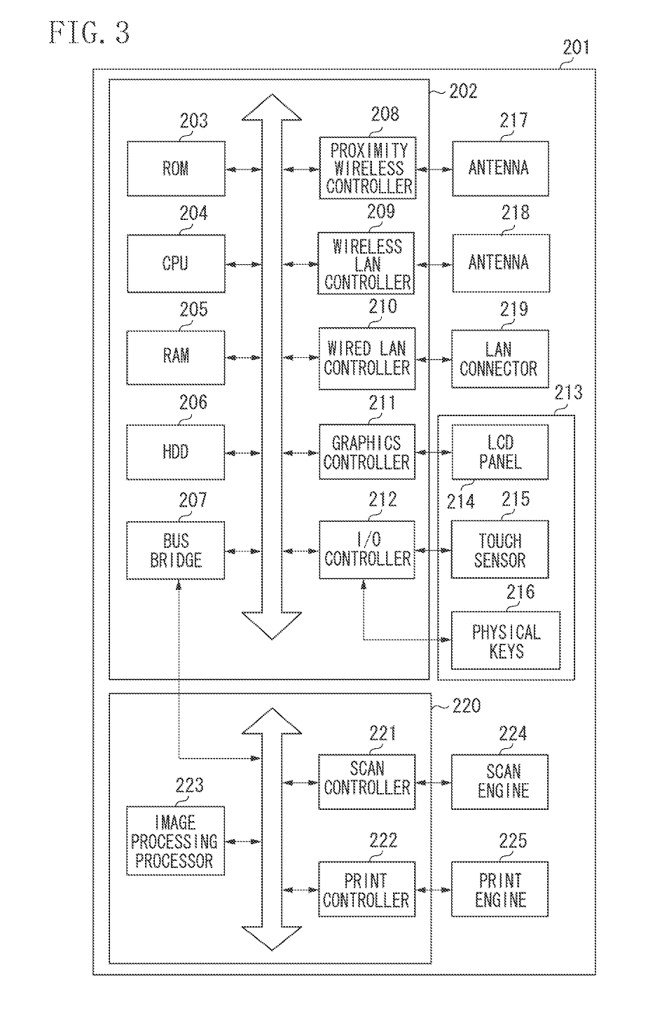

FIG. 3 is a block diagram illustrating an example of the information processing apparatus according to the present exemplary embodiment. This is an example of an inner configuration of an image forming apparatus 201 that is an example of an information processing apparatus having a proximity wireless communication function.

In FIG. 3, the image forming apparatus 201 includes a main base 202, a sub-base 220, a scan engine 224, a print engine 225, antennas 217 and 218, a LAN connector 219, and an operation unit 213, which are housed in an enclosure.

The main base 202 includes a nonvolatile ROM 203 for storing a system boot program and an operating system, and a volatile RAM 205 for temporarily storing a program and data. The main base 202 further includes a hard disk drive (HDD) 206 serving as a nonvolatile memory for storing an application program and data relating to the application program. A CPU 204 sequentially executes the program stored in the ROM 203, the RAM 205, or the HDD 206. A wireless LAN controller 209 performs wireless communication via the antenna 218.

A proximity wireless controller 208 controls proximity wireless communication such as NFC with another apparatus via the antenna 217. The wireless LAN controller 209 controls short-range wireless communication based on, for example, the IEEE 802.11n with another apparatus or an access point via the antenna 218. The main base 202 further includes a wired LAN controller 210 to transmit and receive data to and from other devices connected to a LAN via the LAN connector 219.

The main base 202 further includes a graphics controller 211 for performing display on a display device, and an I/O controller 212 for inputting and outputting data to and from a device connected thereto. The operation unit 213 includes an LCD panel 214 connected to the graphics controller 211 to display image information. The operation unit 213 further includes a touch sensor 215 for detecting the position of a touch of a finger or touch pen on the LCD panel 214, and physical keys 216 such as an Enter button and a numeric keypad. The touch sensor 215 and the physical keys 216 are connected to the I/O controller 212.

The main base 202 further includes a bus bridge 207 for exchanging data between a bus of the main base 202 and a bus of the sub-base 220. The sub-base 220 includes a scan controller 221 for controlling the scan engine 224, and a print controller 222 for controlling the print engine 225. The sub-base 220 further includes an image processing processor 223 for processing an image obtained from the scan engine 224 and an image to be output by the print engine 225.

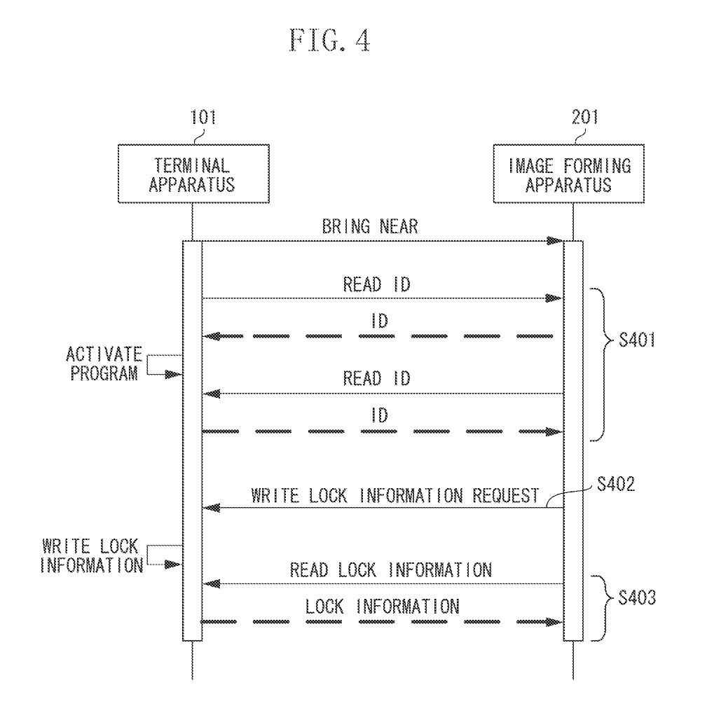

When the terminal apparatus 101 provided with the proximity wireless communication function illustrated in FIG. 1 is brought near to the image forming apparatus 201 provided with the proximity wireless communication function illustrated in FIG. 3, data is exchanged therebetween via the proximity wireless communication. This data will be described below using a sequence diagram illustrated in FIG. 4.

In FIG. 4, when the terminal apparatus 101 is brought near to the image forming apparatus 201, the proximity wireless communication is performed between the proximity wireless controller 108 and the proximity wireless controller 208, via the antenna 117 and the antenna 217.

First, in step S401, the terminal apparatus 101 acquires an ID uniquely assigned to the proximity wireless controller 208 of the image forming apparatus 201, and the image forming apparatus 201 also acquires an ID assigned to the proximity wireless controller 108 of the terminal apparatus 101. Next, in step S402, the image forming apparatus 201 writes a lock information request into a nonvolatile memory (not illustrated) provided in the proximity wireless controller 108 of the terminal apparatus 101, via the proximity wireless controller 208. When the lock information request has been detected, the terminal apparatus 101 acquires the current lock information, and writes the acquired current lock information into the nonvolatile memory provided in the proximity wireless controller 108. In step S403, the image forming apparatus 201 acquires the lock information from the nonvolatile memory provided in the proximity wireless controller 108 of the terminal apparatus 101, via the proximity wireless controller 208.

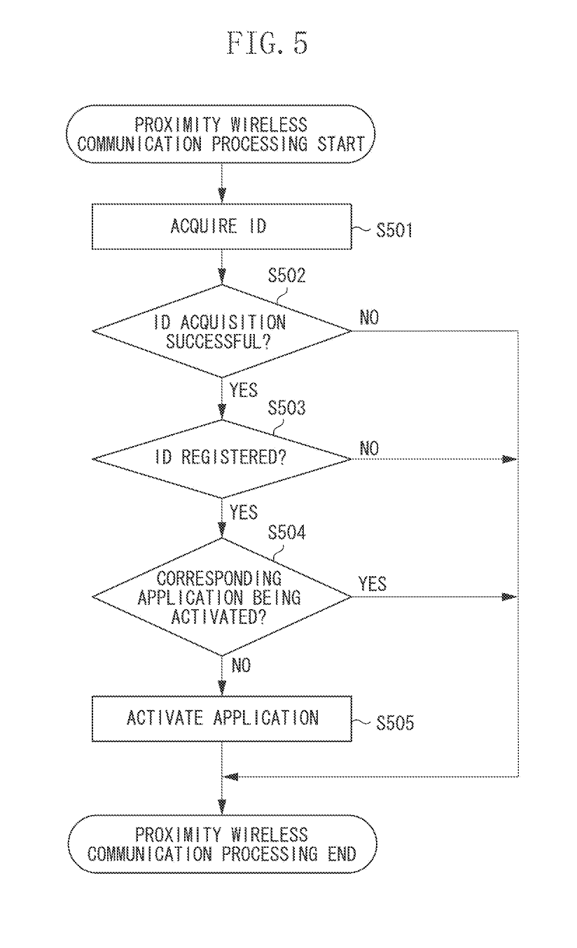

The terminal apparatus 101 and the image forming apparatus 201 each execute processing for allowing the image forming apparatus 201 to be used by bringing the terminal apparatus 101 near to the image forming apparatus 201. This processing will be described with reference to FIG. 5 to FIG. 8.

FIG. 5 is a flowchart illustrating a control method for the terminal apparatus 101 according to the present exemplary embodiment. This is an example of proximity wireless communication processing in the terminal apparatus 101 illustrated in FIG. 1. The CPU 104 of the terminal apparatus 101 implements each step by executing a control program stored in a storage such as the ROM 103.

The processing in FIG. 5 begins when the proximity wireless controller 108 of the terminal apparatus 101 detects the image forming apparatus 201 is in close proximity, via the proximity wireless communication with the proximity wireless controller 208 of the image forming apparatus 201 provided with the proximity wireless communication function illustrated in FIG. 3. Then in step S501 in FIG. 5, the CPU 104 executing the apparatus control program of the terminal apparatus 101 acquires the ID assigned to the proximity wireless controller 208 of the image forming apparatus 201, via the proximity wireless communication. An apparatus provided with a proximity wireless communication function has its own ID for uniquely identifying the apparatus, and such an apparatus transmits and receives the ID to and from a partner apparatus when proximity wireless communication is started upon the apparatuses being in close proximity to each other.

Next, in step S502, the CPU 104 executing the apparatus control program of the terminal apparatus 101 determines whether acquisition of the ID of the image forming apparatus 201 is successful. If the acquisition of the ID fails (NO in step S502), the proximity wireless communication processing ends. If the CPU 104 determines that the acquisition of the ID of the image forming apparatus 201 is successful (YES in step S502), the processing proceeds to step S503. In step S503, the CPU 104 determines whether the acquired ID is registered. If the acquired ID is not registered (NO in step S503), the processing ends.

On the other hand, if the CPU 104 determines that the acquired ID is registered (YES in step S503), the processing proceeds to step S504. In step 5504, the CPU 104 determines whether an application program linked to the acquired ID, e.g., an image forming apparatus application, is activated. If the CPU 104 determines that the application program is activated (YES in step S504), the processing ends.

On the other hand, if the CPU 104 determines that the application program is not activated (NO in step S504), the processing proceeds to step S505. In step S505, the CPU 104 activates the application program, and then the proximity wireless communication processing ends.

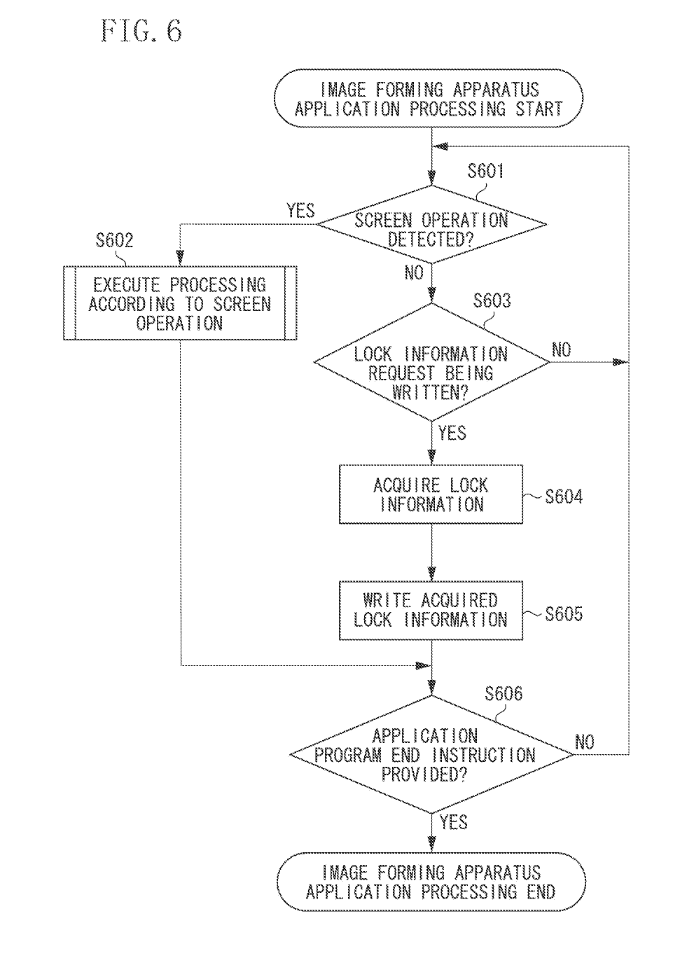

FIG. 6 is a flowchart illustrating the control method for the terminal apparatus 101 according to the present exemplary embodiment. This is an example of processing of the image forming apparatus application (the application program) to be executed by the CPU 104. The CPU 104 illustrated in FIG. 1 implements each step by executing the stored control program (including the image forming apparatus application).

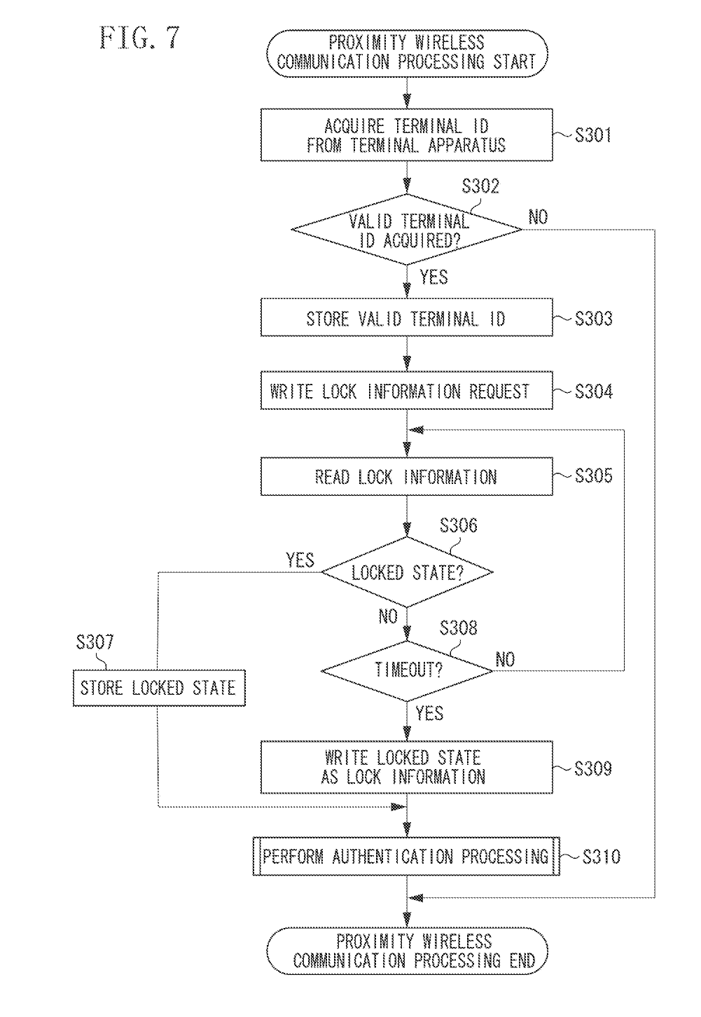

In step S601, the CPU 104 executing the image forming apparatus application determines whether a screen operation such as touching the LCD panel 114 of the terminal apparatus 101 is detected. If the screen operation is detected (YES in step S601), the processing proceeds to step S602. In step S602, the CPU 104 executes processing corresponding to the screen operation, and then the processing proceeds to step S606. If the CPU 104 determines that a screen operation is not detected (NO in step S601), the processing proceeds to step S603. In step S603, the CPU 104 determines whether a request for acquisition of the lock information is written, by referring to the nonvolatile memory provided in the proximity wireless controller 108. Here, if the CPU 104 determines that the request is not written (NO in step S603), the processing returns to step S601. Writing of the request for acquisition of the lock information is to be executed in step S304 of a flowchart in FIG. 7, which is processing of an apparatus control program of the image forming apparatus 201 (described below).

If the CPU 104 determines that the request from the image forming apparatus 201 for the acquisition of the lock information is written (YES in step S603), the processing proceeds to step S604. In step S604, the CPU 104 acquires the lock information indicating the terminal apparatus 101 being in the locked state or unlocked state. Next, in step S605, the lock information corresponding to the locked state or unlocked state is written into the nonvolatile memory provided in the proximity wireless controller 108.

Next, in step S606, the CPU 104 determines whether an application program end instruction from an operator of the terminal apparatus 101 is provided. If the CPU 104 determines that an application program end instruction is not provided (NO in step S606), the processing returns to step S601. If the CPU 104 determines that an application program end instruction is provided (YES in step S606), the present processing ends.

Meanwhile, processing illustrated in FIG. 7 begins when the proximity wireless controller 208 of the image forming apparatus 201 detects that the terminal apparatus 101 is in close proximity via the proximity wireless communication with the proximity wireless controller 108 of the terminal apparatus 101 having the proximity wireless communication function illustrated in FIG. 1.

FIG. 7 is a flowchart illustrating a control method for the information processing apparatus according to the present exemplary embodiment. This is an example of proximity wireless communication processing to be performed by the CPU 204 executing the apparatus control program of the image forming apparatus 201 illustrated in FIG. 3. The CPU 204 illustrated in FIG. 3 implements each step by executing the stored control program (including the apparatus control program). Processing for restricting execution of predetermined functional processing will be described below in detail. This restriction processing is to be executed by the image forming apparatus 201, according to a result of authenticating the ID of the terminal apparatus 101 by using the lock information. Here, examples of the predetermined function include functions executable by the image forming apparatus 201, such as a print function, a scan function, a copy function, and a SEND function.

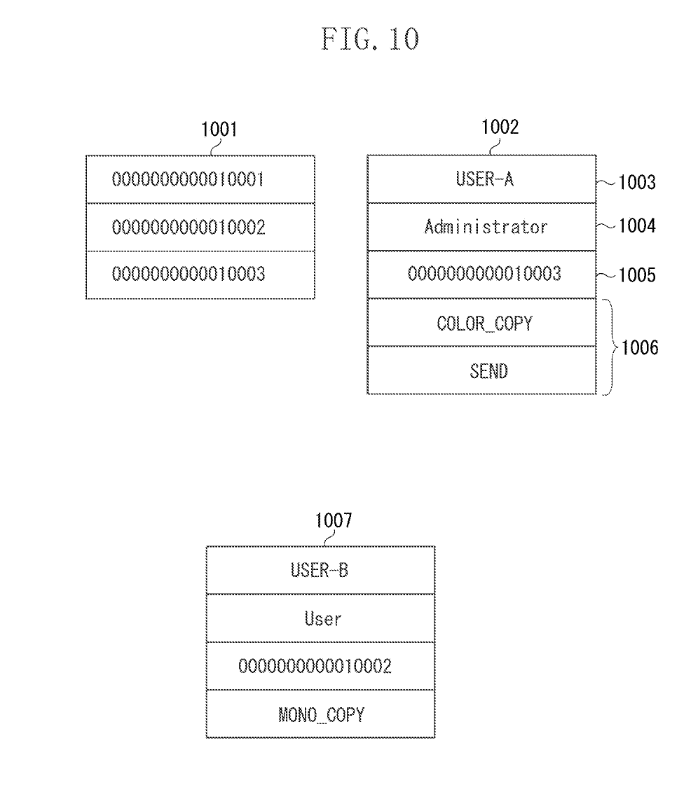

In step S301, the CPU 204 acquires the ID (hereinafter also referred to as “terminal ID”) assigned to the proximity wireless controller 108 of the terminal apparatus 101. In step S302, the CPU 204 determines whether a valid terminal ID is acquired, by executing the apparatus control program of the image forming apparatus 201. If the CPU 204 determines that a valid terminal ID is not acquired (NO in step S302), the present processing ends. In the present exemplary embodiment, the terminal ID is managed by being registered in a table illustrated in FIG. 10 (described below).

On the other hand, in step S302, if the CPU 204 determines that a valid terminal ID is acquired (YES in step S302), the processing proceeds to step S303. In step S303, the CPU 204 stores the acquired terminal ID, into a terminal-ID storage area of the RAM 205. Next, in step S304, the CPU 204 writes the request for acquisition of the lock information via the proximity wireless communication, into the nonvolatile memory provided in the proximity wireless controller 108 of the terminal apparatus 101.

Next, in step S305, the CPU 204 reads the lock information stored in the nonvolatile memory provided in the proximity wireless controller 108 of the terminal apparatus 101. In step S306, the CPU 204 determines whether the read lock information indicates the locked state. Here, if the CPU 204 determines that the lock information indicating the locked state is read (YES in step S306), the processing proceeds to step S307. In step S307, the CPU 204 stores data indicating the locked state into a lock-information storage area of the RAM 205, and then the processing proceeds to step S310. In step S310, the CPU 204 performs authentication processing.

On the other hand, if the CPU 204 determines that the lock information indicating the locked state is not read (NO in step S306), the processing proceeds to step S308. In step S308, the CPU 204 determines whether a predetermined time has elapsed. If the CPU 204 determines that the predetermined time has not elapsed (NO in step S308), the processing returns to step S305.

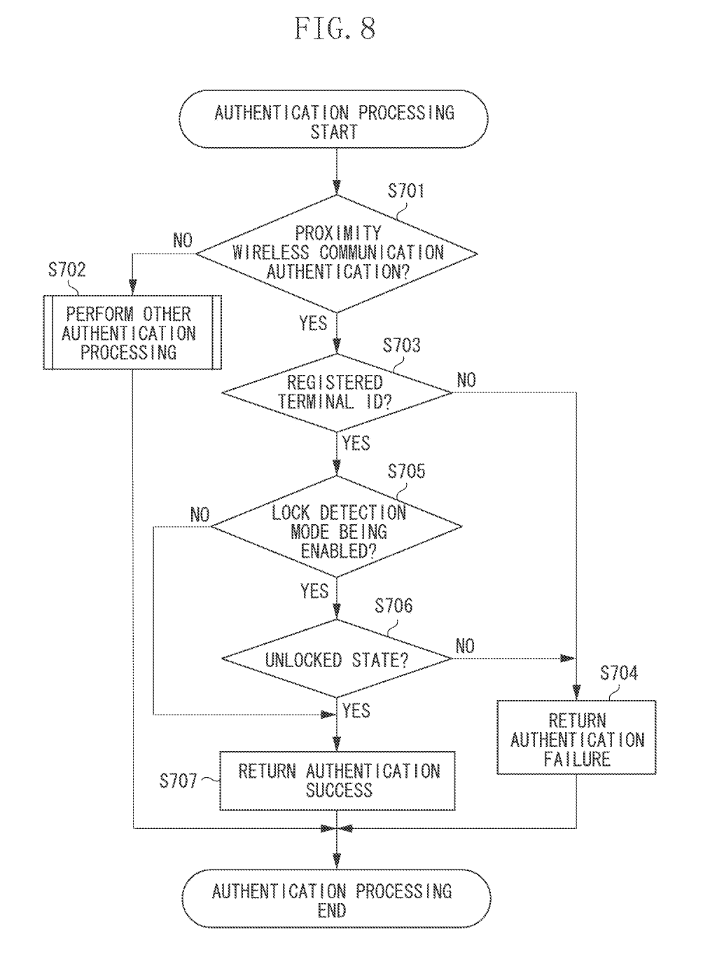

On the other hand, if the CPU 204 determines that the predetermined time has elapsed (YES in step S308), the processing proceeds to step S309. In step S309, the CPU 204 writes data indicating the locked state into the lock-information storage area of the RAM 205 according to a response from the terminal apparatus 101. The CPU 204 assumes the current state to be the locked state, if the CPU 204 determines that the lock information indicating the locked state cannot be acquired within the predetermined time. In such a manner, in subsequent processing, the CPU 204 determines that the terminal apparatus 101 is being used by an unauthorized person who has fraudulently acquired the terminal apparatus 101, i.e., not being used by the authorized user. Next, in step S310, the CPU 204 performs the authentication processing illustrated in FIG. 8.

FIG. 8 is a flowchart illustrating the control method for the information processing apparatus according to the present exemplary embodiment. This is an example of the authentication processing to be performed by the CPU 204 executing the apparatus control program of the image forming apparatus 201 illustrated in FIG. 3. The CPU 204 illustrated in FIG. 3 implements each step by executing the stored control program (including the apparatus control program).

In step S701, the CPU 204 executing the apparatus control program of the image forming apparatus 201 determines whether the authentication processing, which uses the terminal ID of the terminal apparatus 101 acquired by the proximity wireless communication, is enabled in operation settings of the image forming apparatus 201. Here, if the CPU 204 determines that the authentication processing using the terminal ID is not enabled (NO in step S701), the processing proceeds to step S702. In step S702, the CPU 204 executes the authentication processing in a way other than the proximity wireless communication, and then the present processing ends.

In a case where whether or not to perform authentication is not determined based on whether or not the terminal ID acquired by the proximity wireless communication is registered, it may be necessary to perform authentication based on an ID and a password input into the operation unit 213. Accordingly, in step S702, the CPU 204 executes the authentication processing in a way other than the proximity wireless communication.

On the other hand, if the CPU 204 determines that the authentication processing using the terminal ID is enabled (YES in step S701), the processing proceeds to step S703. In step S703, the CPU 204 determines whether the terminal ID is registered, by referring to the terminal-ID storage area of the RAM 205. Here, if the CPU 204 determines that the terminal ID is not registered (NO in step S703), the processing proceeds to step S704. In step S704, the CPU 204 returns information indicating failure of the authentication processing based on the terminal ID, and then the present processing ends. Whether or not the ID is registered is determined based on determination by the CPU 204 as to whether an ID matching with the terminal ID is present in a registered ID list 1001 illustrated in FIG. 10.

On the other hand, if the CPU 204 determines that the terminal ID is registered (YES in step S703), the processing proceeds to step S705. In step S705, the CPU 204 determines whether a lock detection mode is enabled. In the lock detection mode, processing for determining whether a user of the terminal apparatus 101 is an authorized user by using the lock information is performed. Here, if the CPU 204 determines that the lock detection mode is not enabled (NO in step S705), i.e., not to perform determination as to whether the user is an authorized user, the processing proceeds to step S707.

On the other hand, if the CPU 204 determines that the lock detection mode is enabled (YES in step S705), the processing proceeds to step S706. In step S706, the CPU 204 determines whether the current lock information indicates the unlocked (locking release) state by referring to the lock-information storage area of the RAM 205. Here, the CPU 204 may determine that the lock information does not indicate the unlocked state (NO in step S706), i.e., the locked state. In such a case, the CPU 204 determines that the terminal apparatus 101 is brought near to the image forming apparatus 201 by a person other than the authorized user (owner), and the processing proceeds to step S704. In step S704, authentication failure is returned thereto, and then the processing ends.

On the other hand, if the CPU 204 determines that the lock information of the terminal apparatus 101 indicates the unlocked state (YES in step S706), the CPU 204 determines that the terminal apparatus 101 is brought near to the image forming apparatus 201 by the authorized user (owner). In this case, in step S707, authentication success is returned thereto, and then the processing ends.

The apparatus control program of the image forming apparatus 201 is configured to allow a user to use the image forming apparatus 201 when authentication success is returned, and to prohibit a user to use the image forming apparatus 201 when authentication failure is returned, in the authentication processing illustrated in the flowchart in FIG. 8.

According to the present exemplary embodiment, the terminal apparatus 101 having the proximity wireless communication function is brought near the image forming apparatus 201 having the proximity wireless communication function likewise. With the close proximity, when the proximity wireless communication is established, the image forming apparatus 201 acquires the lock information (the locked state) of the terminal apparatus 101, if the terminal ID of the terminal apparatus 101 brought near is registered beforehand. Here, if the lock information indicates the unlocked (locking release) state, the user is allowed to use the image forming apparatus 201.

On the other hand, if the lock information of the terminal apparatus 101 is determined to indicate the locked state, the user is not allowed to use the image forming apparatus 201, as in the case where the terminal ID is not registered. This configuration can prevent such spoofing that a person different from an authorized user attempts to use the image forming apparatus 201 by bringing the terminal apparatus 101 with the registered terminal ID near to the image forming apparatus 201.

A second exemplary embodiment of the present invention will be described below. In the first exemplary embodiment described above, whether or not the image forming apparatus 201 can be used is determined based on whether or not the terminal apparatus 101 is in the locked state or unlocked state. However, the terminal apparatus 101 may be in the unlocked state due to absence of a locking release method, i.e., the terminal apparatus 101 may be always in the unlocked state.

Further, for example, when the terminal apparatus 101 is in the unlocked state in a case where locking release is performed based on the fingerprint authentication that is an example of biometric authentication, it can be assumed that the terminal apparatus 101 is certainly used by the owner. In this way, a possibility that the terminal apparatus 101 is used by the owner varies depending on the locking release method. Therefore, functions of the image forming apparatus 201 available to the image forming apparatus 201 may be restricted depending on the locking release method of the terminal apparatus 101.

FIG. 10 is a diagram illustrating an example of a data structure of the registered ID list 1001 and user entries 1002 and 1007, which are stored in a nonvolatile storage such as the HDD 206 of the image forming apparatus 201.

In FIG. 10, the ID assigned to the proximity wireless controller 108 of the terminal apparatus 101, which is permitted to use the functions provided by the image forming apparatus 201, is recorded in the registered ID list 1001. In step S703 in FIG. 8, whether or not the acquired ID is a registered ID is determined based on whether or not the ID acquired from the proximity wireless controller 108 of the terminal apparatus 101 brought near to the image forming apparatus 201 matches with any of IDs recorded in this list.

A user entry 1002 is data indicating user information. For example, the user entry 1002 includes a user name 1003, a role 1004, an ID 1005, and available functions 1006. The user entry 1002 is an entry made by a user USER-A, and indicates that the role 1004 is an administrator, the ID 1005 is “0000000000010003”, and the available functions 1006 are a color copy function and a data send function.

A user entry 1007 is an entry made by a user USER-B, and indicates that the role is a general user, the ID is “0000000000010002”, and the available function is a monochrome copy function.

For example, assume that the terminal apparatus 101 having “0000000000010003” as the ID assigned to the proximity wireless controller 108 is brought near to the image forming apparatus 201 that stores the registered ID list 1001 and the user entries 1002 and 1007 illustrated in

FIG. 10. In such a case, authentication in the image forming apparatus 201 is successful because the ID is included in the register ID list 1001, and the image forming apparatus 201 can be used based on the authority of the user USER-A having this ID.

First, when acquiring the lock information indicating whether the current state of the terminal apparatus 101 is in the locked state in step S604 of the flowchart in FIG. 6, the image forming apparatus application running in the terminal apparatus 101 also acquires the locking release method in addition to the locked information. Next, in step S605, the acquired locking release method is written. Similarly, in the proximity wireless communication processing of the image forming apparatus 201, the apparatus control program of the image forming apparatus 201 may provide additional control, when the lock information is read in step S305 of the flowchart in FIG. 7. More specifically, for example, it is desirable to add such control that the locking release method is read in addition to the lock information in step S305, and then, the read locking release method is stored into the lock-information storage area of the RAM 205 in step S307.

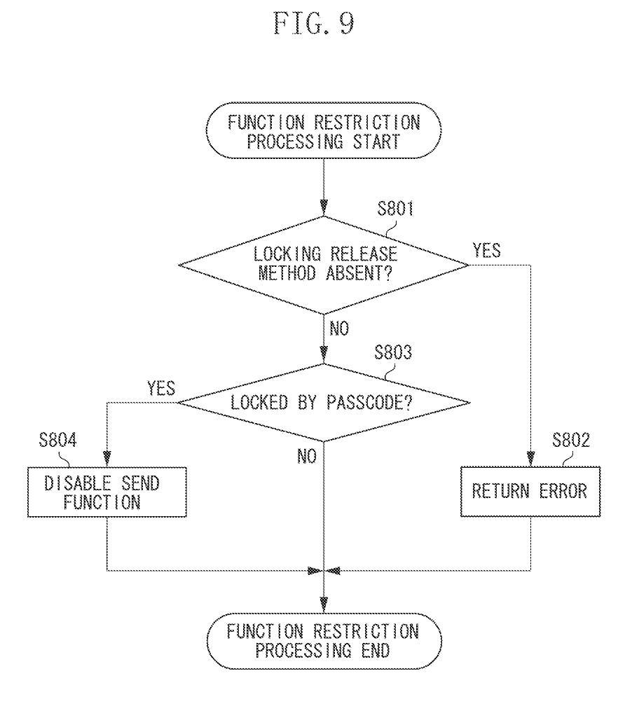

FIG. 9 is a flowchart illustrating a control method for the information processing apparatus according to the present exemplary embodiment. This is an example of function restriction processing, which is performed by the CPU 204 executing the apparatus control program of the image forming apparatus 201, when authentication success is returned thereto in the above-described authentication processing. The CPU 204 illustrated in FIG. 3 implements each step by executing the stored control program (including the apparatus control program).

First, in step S801, the CPU 204 executing the apparatus control program of the image forming apparatus 201 refers to the lock-information storage area of the RAM 205 and determines whether a locking release method is registered beforehand (i.e., whether a locking release method is absent),. Here, if the CPU 204 determines that no locking release method is registered (YES in step S801), the processing proceeds to step S802. In step S802, an error is returned thereto, and then the processing ends.

In addition, that the CPU 204 executing the apparatus control program of the image forming apparatus 201 disables the use of the image forming apparatus 201, as in the authentication failure, when the error returned from the function restriction processing is detected.

In step S803, the CPU 204 executing the apparatus control program of the image forming apparatus 201 determines whether or not the registered locking release method (an authentication attribute) is passcode authentication (first authentication). Here, if the CPU 204 determines that the registered locking release method is the passcode authentication (YES in step S803), the processing proceeds to step S804. In step S804, the image forming apparatus 201 is controlled to disable a function for sending data to outside such as a facsimile function, and to enable other functions.

On the other hand, if the CPU 204 determines that the registered locking release method is authentication other than the passcode authentication (NO in step S803), i.e., a method allowing more accurate personal authentication (second authentication) such as fingerprint authentication, the function restriction is not performed.

For example, assume that the terminal apparatus 101 having “0000000000010003” as the ID assigned to the proximity wireless controller 108 is brought near to the image forming apparatus 201, as described above. In such a case, the image forming apparatus 201 is set so as to allow, the user to use the color copy function and the data send function are based on the authority assigned to the user “USER-A”. However, if the CPU 204 determines that the registered locking release method is the passcode authentication in step S803, then in step S804, the data send function is disabled. Therefore, the user can use only the color copy function.

According to the present exemplary embodiment, in addition to the information indicating whether the terminal apparatus 101 is locked or unlocked, the use of the image forming apparatus 201 is restricted based on the locking release method, by transmitting and receiving the information about the locking release method to and from the terminal apparatus 101 and the image forming apparatus 201. In such a manner, for example, when the terminal apparatus 101 that may be used by a person other than the owner is brought near to the image forming apparatus 201, a function that may lead to information leakage is disabled, so that a security level can be raised.

A third exemplary embodiment of the present invention will be described below. In the second exemplary embodiment, the availability level of the image forming apparatus 201 is changed based on the locking release method of the terminal apparatus 101. Further, the role of the user may be changed based on the locking release method.

The second exemplary embodiment is described using the example in which a user is authenticated to be the user USER-A. Since the user USER-A has the administrator role, the user USER-A can change settings of the image forming apparatus 201, such as addition of a user. Accordingly, in a case where a locking release method is the passcode authentication in step S803 of the flowchart in FIG. 9 (YES in step S803) then, in step S804, the CPU 204 executing the apparatus control program of the image forming apparatus 201 disables the data send function. Afterward, processing of determination as to whether the current user is an administrator is added, and if the current user is determined to be the administrator (YES), the role of the current user is changed to a general user.

According to the present exemplary embodiment, if a possibility of spoofing by an unauthorized person is determined to be exist based on the locking release method, the user role is changed to the general user. This configuration can avoid a security risk, such as changing the settings of the image forming apparatus 201, and data deletion.

Further, a slave terminal (e.g., a smartwatch), which notifies the user of information such as an incoming call by wireless communication with the terminal apparatus 101, may be coordinated. In such a case, operation of the image forming apparatus 201 can be restricted through the ID authentication of the terminal apparatus 101, if the slave terminal and the terminal apparatus 101 are positioned an appropriate distance apart.

According to the exemplary embodiments of the present invention, when the terminal apparatus is brought near to the information processing apparatus, even if the identification information of the terminal apparatus is registered, the functional processing can be restricted by determining whether the owner operates the terminal apparatus from the locked state of the terminal apparatus, or an unauthorized person operates the terminal apparatus.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention not limited to the disclosed exemplary embodiments. The scope of the following claims is to be accorded the broadest interpretation so as to encompass all such modifications and equivalent structures and functions.

1. A communication system comprising:
a mobile terminal having at least a locked state and an unlocked state; and
a printing apparatus configured to provide a function to an authenticated user,
the mobile terminal comprising
a first proximity wireless communication unit;
at least one memory that stores a set of instructions; and
at least one processor that executes the instructions, the instructions, when executed, causing the mobile terminal to perform operations comprising:
writing data to be transmitted to an external apparatus using the first proximity wireless communication unit, wherein different pieces of data are written depending on whether the mobile terminal is in a locked state or in an unlocked state, and
the printing apparatus comprising
a second proximity wireless communication unit;
at least one memory that stores a set of instructions; and
at least one processor that executes the instructions, the instructions, when executed, causing the printing apparatus to perform operations comprising:
receiving an identification (ID) of the mobile terminal and data stored in the mobile terminal via the second proximity wireless communication unit;
determining whether to provide the function of the printing apparatus to a user associated with the ID based on the ID and the data received from the mobile terminal; and
performing control in such a manner that the printing apparatus comes into a state usable by the user associated with the ID in response to the determination to provide the function of the printing apparatus to the user associated with the ID.

2. The communication system according to claim 1, wherein the processor of the printing apparatus executes the instructions to cause the printing apparatus to perform operations comprising:
determining whether a lock detection mode is enabled in the printing apparatus;
in a case where it is determined that the lock detection mode is not enabled, determining to provide the function of the printing apparatus to the user associated with the ID if an ID of the mobile terminal received by the proximity wireless communication unit is registered in an ID list, and determining not to provide the function of the printing apparatus to the user associated with the ID if the ID of the mobile terminal received by the proximity wireless communication unit is not registered in the ID list, and
in a case where it is determined that the lock detection mode is enabled, determining to provide the function of the printing apparatus to the user associated with the ID if the ID of the mobile terminal received by the proximity wireless communication unit is registered in the ID list and if it is determined, based on the data, that the mobile terminal is in the unlocked state, and determining not to provide the function of the printing apparatus to the user associated with the ID if it is determined, based on the data, that the mobile terminal is in the locked state even when the ID of the mobile terminal received by the proximity wireless communication unit is registered in the ID list.

3. The communication system according to claim 1, wherein, in a case where the printing apparatus comes into a state usable by the user associated with the ID, at least one of a copy function and a scan function becomes usable.

4. The communication system according to claim 1, wherein a printing apparatus application is installed in the mobile terminal and the processor of the mobile terminal performs the writing of the data by executing instructions of the printing apparatus application program.

5. The communication system according to claim 4, wherein the printing apparatus application of the mobile terminal acquires a status of the mobile terminal from the mobile terminal and writes the data based on the acquired status.

6. The communication system according to claim 1, wherein the ID of the mobile terminal received by the second proximity wireless communication unit is a unique ID assigned to the first proximity wireless communication unit.
